(19) United States
(12) Patent Application Publication
(10) Pub. No.: US 2019/0141921 A1
(43) Pub. Date: May 16, 2019

(54) APPARATUS FOR VERTICAL AGRICULTURE

(71) Applicants: Timothy Patrick Tempany, Calgary, CA (US); William Thomas TEMPANY, Calgary, CA (US)

(72) Inventors: Timothy Patrick Tempany, Calgary, CA (US); William Thomas TEMPANY, Calgary, CA (US)

(21) Appl. No.: 16/175,437

(22) Filed: Oct. 30, 2018

Related U.S. Application Data
(60) Provisional application No. 62/578,983, filed on Oct. 30, 2017.

(51) Int. Cl. A01G 27/00; A01G 31/04; A01G 9/02; A01G 9/24

(52) U.S. Cl. CPC A01G 27/006; A01G 31/042; A01G 9/247; A01G 27/001; A01G 9/024

(57) ABSTRACT

A vertical agriculture apparatus is provided, including a drive mechanism, chain tensioning mechanism, connection assembly for connecting trays to a roller chain, tray assemblies, tray hangers, and a watering system. The watering system includes seal members attached to a spring-biased moveable member that is actuated by a surface attached to a tray. The connection assembly includes a connector member defining an inner aperture for receiving pins of a roller chain and an outer aperture for receiving a bolt or rod passing through a tray aperture. The apparatus has a tray that is supported on first and second vertical loops at positions that are spaced apart in two perpendicular horizontal directions. Water is added to the trays on a downward leg of the vertical loop to drive travel of the vertical loop or augment a drive mechanism.

### FIELD OF THE INVENTION

The present invention relates to apparatuses for vertical agriculture and components thereof.

### BACKGROUND OF THE INVENTION

Traditional agriculture and plant growing systems require horizontal expanses due to light and moisture requirements. Vertical agriculture refers to growing plants in vertically stacked tiers or containers. The prior art includes apparatuses in which a chain drive mechanism moves trays holding plant growth media in a vertical loop: see U.S. Pat. No. 4,317,308 (Derrick et al.); U.S. Patent Application Publication No. 2009/0307973 A1 (Adams et al.); U.S. Patent Application Publication No. 2015/0305260 A1; and U.S. Patent Application Publication No. 2017/0055471 A1.

Despite these advances, there remains a need in the art for a vertical agriculture apparatus which may allow effective, convenient and efficient vertical agriculture.

### SUMMARY OF THE INVENTION

In one aspect, the invention comprises a watering system for use with a vertical agriculture apparatus comprising a tray for holding a plant growth medium, and a drive mechanism for moving the tray in a vertical loop, the watering system comprising:
(a) a first reservoir;
(b) a first seal member;
(c) a moveable member to which the first seal member is attached, wherein the moveable member is moveable between a first position wherein the first seal member prevents fluid communication from the first reservoir to the tray, and a second position wherein the first seal member permits fluid communication from the first reservoir to the tray;
(d) a spring for biasing the moveable member to the first position; and
(e) an actuator for direct or indirect attachment to the tray, the actuator comprising a surface contoured to move the moveable member from the first position to the second position when the surface is moved, by the tray, in engagement with the moveable member.

In an embodiment of the watering system, the watering system further comprises a second seal member attached to the moveable member, wherein when the movable member is in the first position, the second seal member prevents fluid communication from a second reservoir to the first reservoir, and wherein when the moveable member is in the second position, the second seal member permits fluid communication from the second reservoir to the first reservoir.

In an embodiment of the watering system, the vertical agriculture apparatus further comprises a tray insert defining an aperture above a bottom surface of the tray, and the watering system further comprises a tubular insert for insertion into the aperture to direct fluid from the first reservoir to the tray, and wherein the actuator is attached to the tubular insert.

In another aspect, the invention comprises a connection assembly for use with a vertical agriculture apparatus comprising a tray assembly for holding a plant growth medium and defining a tray aperture, and a drive mechanism comprising a roller chain for moving the tray in a vertical loop, the roller chain comprising a plurality of pins connecting an associated pair of opposed plates. The connection assembly comprises a connector member defining: an inner aperture for receiving one of the pins of the roller chain, and disposed between the associated pair of opposed plates; and an outer aperture for alignment with the tray aperture and receiving therethrough a bolt or rod when aligned with the tray aperture.

In one embodiment of the connection assembly, the connection assembly further comprises a pair of nuts attached to a threaded portion of the bolt or rod and engaged with the tray to limit translational movement of the tray to the rod.

In another aspect, the present invention comprises a tray hanger for pivotally suspending a tray for holding a plant growth medium from a rod connected to a drive chain or belt in an apparatus for vertical agriculture, the tray hanger comprising:
(a) a lower portion for attachment to the tray; and
(b) an upper portion defining a plurality of horizontally spaced apart apertures sized to pivotally receive the rod.

In another aspect, the present invention comprises a vertical agriculture apparatus comprising:
(a) a vertical frame;
(b) a first belt or chain forriring a first vertical loop;
(c) a second belt or chain forming a second vertical loop, wherein the first vertical loop and the second vertical loop are spaced apart from each other in a first horizontal direction;
(d) a tray for holding a plant growth medium attached, wherein a first portion of the tray is attached to the first loop, and a second portion of the tray is attached to the second loop, wherein the first portion of the tray and the second portion of the tray are spaced apart from each other in the first horizontal direction and a second horizontal direction perpendicular to the first horizontal direction; and
(e) a drive mechanism for moving the first belt and the second belt, and thereby drive the tray in a continuous vertical loop.

One embodiment of the vertical agriculture apparatus comprises a tray hanger for pivotally suspending the tray from a rod connected to the first and second drive chain or belt, the tray hanger comprising: a lower portion for attachment to the tray; and an upper portion defining a plurality of horizontally spaced apart apertures sized to pivotally receive the rod. The apparatus may further comprise a ratchet bearing associated with the rod for limiting rotation of the rod or the tray hanger in one direction.

One embodiment of the vertical agriculture apparatus further comprise a watering system as described above.

One embodiment of the vertical agriculture apparatus further comprises a connection assembly as described above.

One embodiment of the vertical agriculture apparatus comprises a plurality of trays spaced apart along the drive chain or belt, and a watering system configured to add water to the trays on a downward leg of the vertical loop

In another aspect, the present invention comprises a method of driving a vertical agriculture apparatus comprising a vertical frame, a pair of drive belts or chains, each forming spaced-apart parallel vertical loops, a tray for holding a plant growth medium attached between the drive belts or chains. The method comprises the step of adding water to the tray on a downward leg of the vertical loop, thereby gravity assisting the descent of the tray, to independently drive the travel of the vertical loop, or augment a drive mechanism.

### BRIEF DESCRIPTION OF THE DRAWINGS

In the drawings shown in the specification, like elements may be assigned like reference numerals. The drawings are not necessarily to scale, with the emphasis instead placed upon the principles of the present invention. Additionally, each of the embodiments depicted are but one of a number of possible arrangements utilizing the fundamental concepts of the present invention.

FIG. 1 shows a schematic drawing of a front view of an embodiment of an apparatus of the present invention.

FIGS. 2A and 2B show side views of an upper portion and a lower portion, respectively, of one embodiment of an apparatus of the present invention.

FIG. 3 shows a perspective view of an embodiment of a frame of an apparatus of the present invention.

FIG. 4A shows a front schematic view of the roller chain looped around eight sprockets in the drive mechanism of the apparatus of FIGS. 2A and 2B. FIG. 4B shows one of the top corner sprockets of the apparatus of FIGS. 2A and 2B. FIG. 4C shows one of the intermediate sprockets of the apparatus of FIGS. 2A and 2B. FIG. 4D shows one of the bottom corner sprockets of the apparatus of FIGS. 2A and 2B. FIG. 4E shows an electric motor that provides a moving force to the roller chain in the apparatus of FIGS. 2A and 2B.

FIGS. 5A and 5B show a front view and a side view, respectively, of an embodiment of a chain tensioning mechanism in the apparatus of FIGS. 2A and 2B.

FIGS. 6A and 6B show perspective views of another embodiment of the chain tensioning mechanism in an apparatus of the present invention, when assembled and disassembled, respectively.

FIG. 7A shows an embodiment of a connector member in isolation for use in an apparatus of the present invention. FIG. 7B shows the connector member of FIG. 7A when attached to a roller chain. FIG. 7C shows an embodiment of a connector member that connects a roller chain to a tray assembly having a tray hanger, in accordance with the embodiment of the apparatus of FIGS. 2A and 2B.

FIG. 8A shows a side view of an embodiment of a tray assembly for an apparatus of the present invention. FIG. 8B shows the tray assembly of FIG. 8A when holding cups that contain foam inserts in which plants are grown. FIG. 8C shows a front view of another embodiment of a tray assembly for an apparatus of the present invention.

FIG. 9 shows a front view of an alternative embodiment of a tray hanger in relation to a tray, for an apparatus of the present invention.

FIG. 10 shows an embodiment of a watering system in relation to the tray, for an apparatus of the present invention.

FIG. 11A shows a disassembled perspective view of an embodiment of an alternative watering system, for an apparatus of the present invention. FIG. 11B shows an assembled perspective view of a sub-assembly of the watering system of FIG. 11A. FIG. 11C shows a partial cut-away view of the sub-assembly of FIG. 11B. FIGS. 11D and 11E show mid-line cross-sectional views of the sub-assembly of FIG. 11B when the moveable member is in the first position and the second position, respectively. FIGS. 11F to 11J show a sequence of views depicting the operation of the watering system of FIG. 11B, and the resulting flow of water. FIG. 11K shows an embodiment of an apparatus of the present invention including the embodiment of the watering system of FIG. 11A.

FIG. 12 shows another embodiment of an apparatus of the present invention, before the tray assemblies are attached to roller chains.

FIG. 13 shows the connection of one of the tray assemblies to the roller chains in the embodiment of the apparatus of FIG. 12.

FIGS. 14A, 14B and 14C show a bottom plan view, an end elevation view and a side elevation view, respectively, of another embodiment of a tray, which may be used with the embodiment of the apparatus shown in FIGS. 12 and 13.

### DETAILED DESCRIPTION OF PREFERRED EMBODIMENT

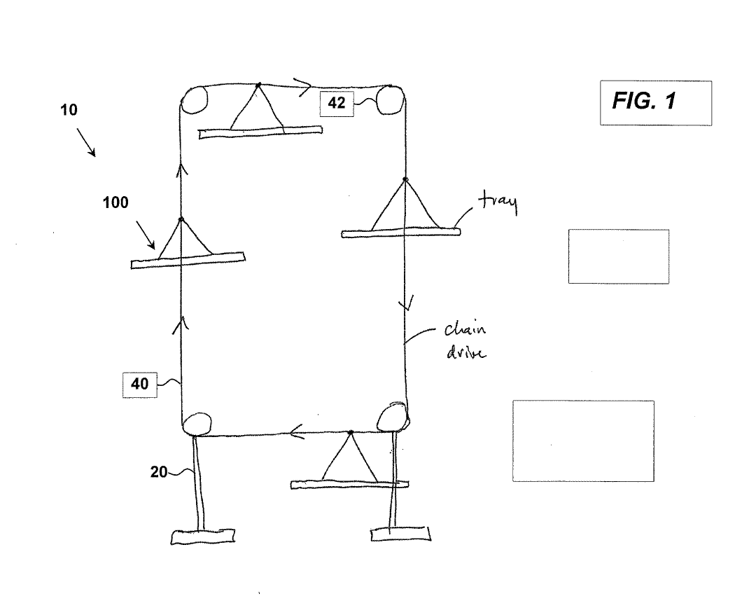

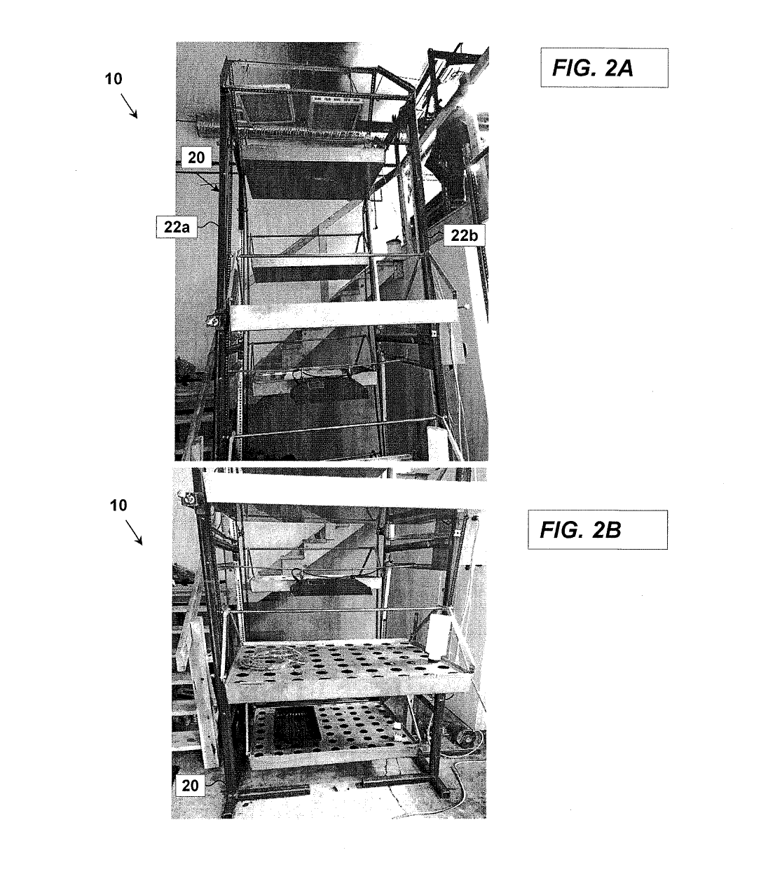

Overview. The present invention relates to vertical agriculture apparatuses. As used herein, a “vertical agriculture apparatus” refers to an apparatus comprising a plurality of trays, each holding a plant growth medium, and a drive mechanism for moving the trays in a vertical loop. As used herein, a “vertical loop” means the continuous path followed by a tray which is substantially in the vertical plane, has an upward leg, a rearward leg, a downward leg and a forward leg which returns to the start of the upward leg. FIG. 1 shows a schematic drawing of a front view of an embodiment of an apparatus (10) of the present invention. The apparatus (10) includes a frame (20), a drive mechanism including a drive belt or chain (40) looped around a plurality of vertically spaced apart pulleys or sprockets (42), a plurality of tray assemblies (100) and other parts, as are further described below. FIGS. 2A and 2B show side views of an upper portion and a lower portion, respectively, of one embodiment of a vertical agriculture apparatus (10) of the present invention.

Frame. The vertical frame (20) supports the other components of the apparatus (10) above the ground surface.

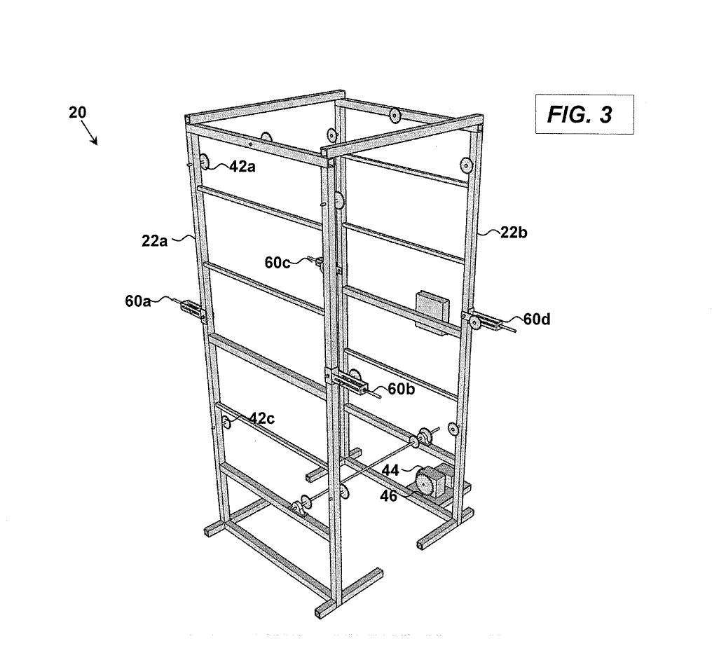

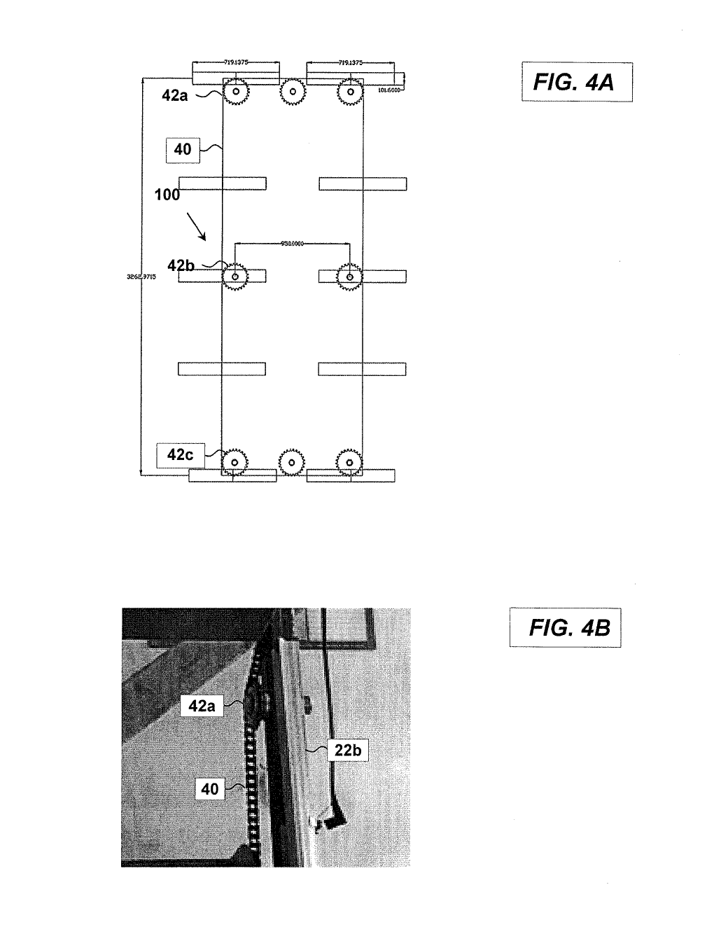

FIG. 3 shows a perspective view of an embodiment of a frame (20). In this embodiment, the frame (20) has a front frame portion (22a) and a rear frame portion (22b). Each frame portion (22) is made of up elongate steel members having hollow, square cross-sections that are welded together. Although actual dimensions are not an essential element of the invention, two vertical members are about 14 feet (4.25 meters) long and horizontally spaced apart widthwise by about 4 feet (1.22 meters). Horizontal members connect the vertical members to form a ladder-like structure. In the embodiment shown in FIGS. 2A and 2B, the horizontal member at the base of the frame portion (22) is about 6 feet (1.83 meters) wide, thus extending widthwise past the vertical members to stabilize the frame portion (22). Two horizontal members extend transversely to the ladder-like structure to provide stability of the frame portions (22). The frame (20) further includes a plurality of elongate steel members, some of which connect the front frame portion and the rear frame portion, and others of which may be used as mounting points for lighting equipment associated with the apparatus.

In other embodiments, the frame (20) may be made of other materials, have a different arrangement of members, and have different dimensions provided that the frame (20) is sufficiently strong to support the weight of the other components of the apparatus (10), and any plants and plant growth media, with which the apparatus (10) is to be used.

Drive mechanism. The drive mechanism moves the tray assemblies (100) in a vertical loop within or around the frame (20). In one embodiment, as shown in FIGS. 2A and 2B, the drive mechanism is a chain drive mechanism comprising a roller chain (40) looped around vertically spaced apart sprockets (42), associated with each frame portion (22a, 22b).

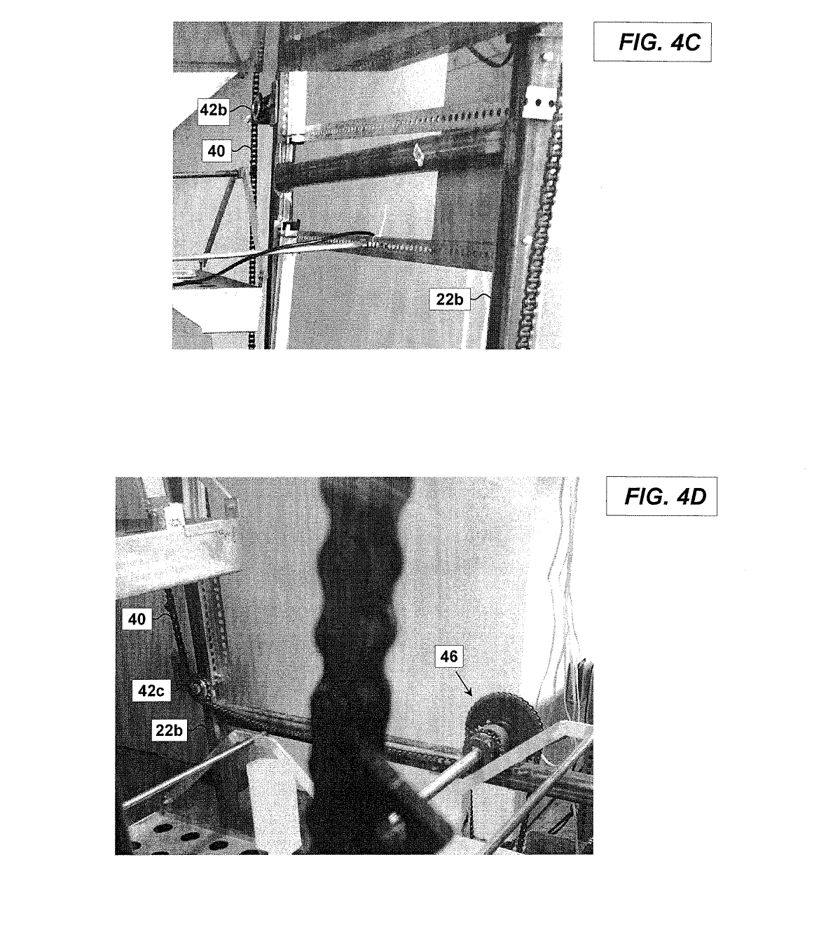

FIG. 4A shows a front schematic view of the roller chain (40) looped around eight sprockets (42) in the drive mechanism of the apparatus of FIGS. 2A and 2B. FIG. 4B shows one of the top corner sprockets (42a) of the apparatus of FIGS. 2A and 2B. FIG. 4C shows one of the intermediate sprockets (42b) of the apparatus of FIGS. 2A and 2B. FIG. 4D shows one of the bottom corner sprockets (42c) of the apparatus of FIGS. 2A and 2B. FIG. 4E shows an electric motor (44) that provides a moving force to the roller chain (40) in the apparatus of FIGS. 2A and 2B.

The electrical motor (44) has a drive shaft in driving engagement with the roller chain (40) looped around the sprockets via a drive sprocket and roller chain assembly (46) (see FIGS. 3 and 4D). The motor (44) may be powered by any electrical power source including wind or solar power. In embodiments, a motor timer may be used to control the supply of power to the motor (44). An example of a suitable motor timer is a Sinotimer TM-616™ programmable digital timer (Yueqing Xinyang Automation Equipment Co., Ltd., China). In some embodiments, an electric motor controller may be used to provide precise motor control.

In other embodiments (not shown), the drive mechanism may comprise a belt drive mechanism comprising a drive belt looped around at least two vertically spaced apart pulleys. In other embodiments (not shown), the number and arrangement of pulleys or sprockets (42) may differ from that shown in the exemplary embodiment, provided that at least two of the pulleys or sprockets are vertically spaced apart from each other such that the drive belt or chain can form a vertical extending loop around them.

In one embodiment, the drive mechanism may be augmented or replaced by a gravity drive mechanism coupled with a water delivery system. If water is added to the trays at the start of the downward leg of the vertical loop, sufficient water may evaporate or be lost through plant transpiration such that the difference in weight between the trays in the upward leg and the downward leg may drive the mechanism, or augment the drive mechanism.

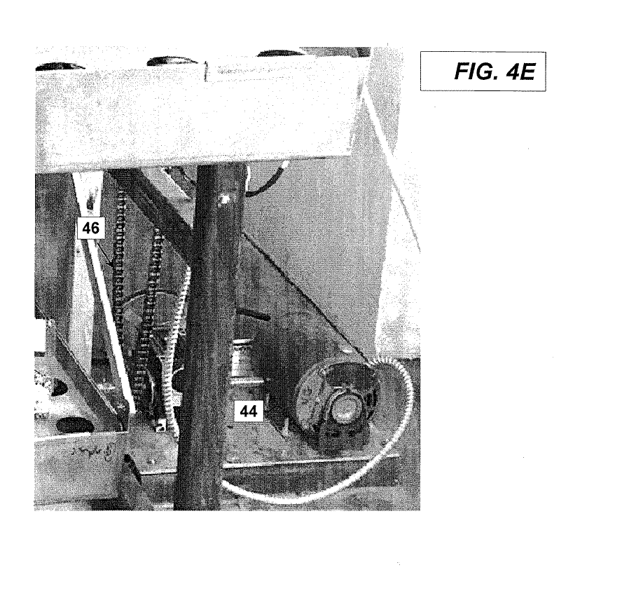

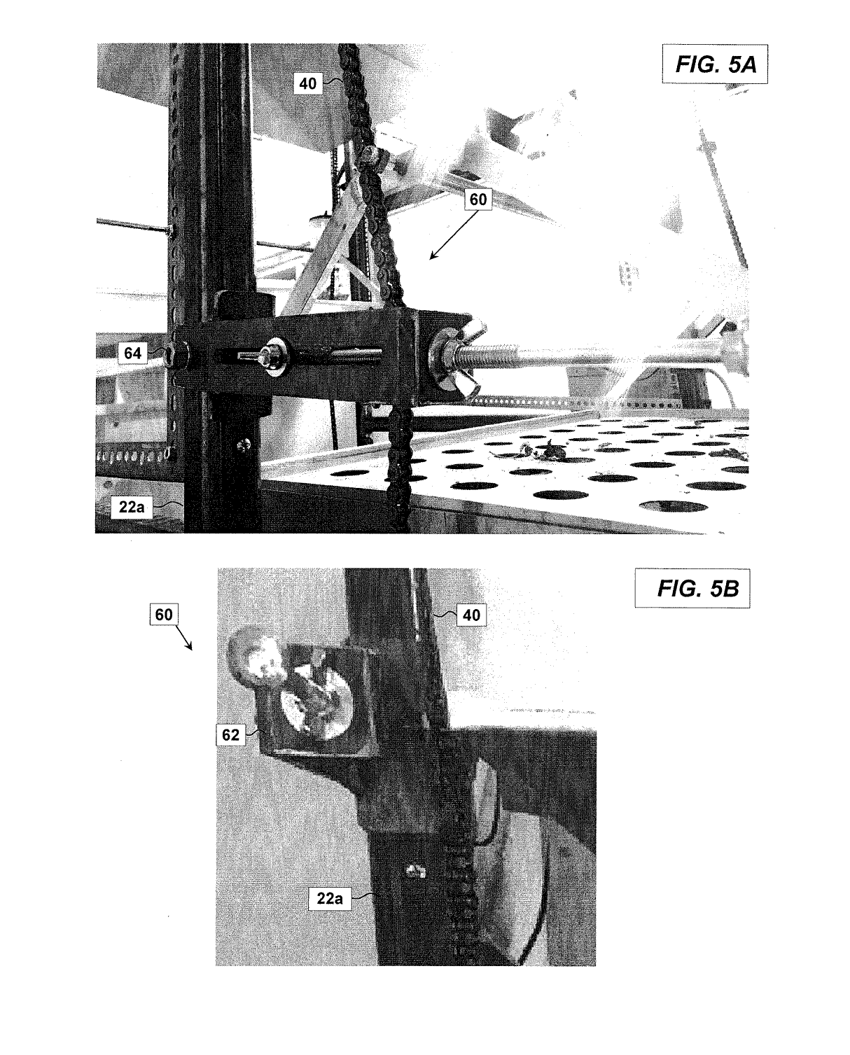

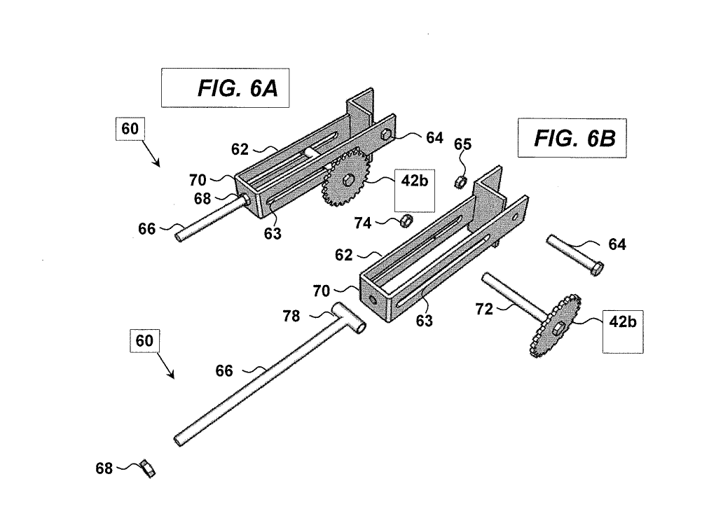

Chain tensioning mechanism. A chain tensioning mechanism (60) may be provided to maintain the roller chain (40) in a taut loop around the sprockets (42). FIGS. 5A and 5B show a front view and a side view, respectively, of an embodiment of a chain tensioning mechanism (60) in the apparatus of FIGS. 2A and 2B. One such chain tensioning mechanism (60) is attached to each vertical member of each frame portion (22a, 22b), thus providing two chain tensioning mechanisms per roller chain (40). FIGS. 6A and 6B show perspective views of another embodiment of the chain tensioning mechanism (60), when assembled and disassembled, respectively.

As shown FIGS. 5A and 5B, and 6A and 6B, the embodiments of the chain tensioning mechanism (60) include a slotted member (62) measuring about 8 inches in length, which may be made from a steel member having a hollow, square cross-section like the other members of the frame (20). The slotted member (62) is secured to the vertical member of the frame (20) using a first bolt (64) passing through aligned apertures of the slotted member (62) and the vertical member of the frame (20), and a nut (65). A second bolt (66) is disposed lengthwise within the slotted member (62), and secured by nut (68) in bearing relationship with an end plate (70) of the slotted member (62). One of the intermediate sprockets (42b) of the drive mechanism is attached to a third bolt (72) that passes through the slots (63) of the slotted member (62), and is secured with a nut (74). The third bolt (72) is attached transversely to the second bolt (66) so that axial movement of the second bolt (66) relative to the slotted member (62) results in translating movement of the third bolt (72) relative to the slotted member (62), as guided by the slots (63). The third bolt (72) may be attached to the second bolt (66) by any suitable means known in the art. For example, in the embodiment of FIGS. 6A and 6B, the third bolt (72) has a threaded ring (76) between its ends, which screws onto the first bolt (66). As another example, in the embodiment of FIGS. 5A and 5B, the third bolt (72) passes through a tubular fitting (78) at the end of the second bolt (66). To adjust the tension in the chain (40), nuts (68, 74) are unscrewed to allow for movement of the sprocket (42b) relative to the frame (20). When the sprocket (42b) is in the desired position, nut (68) and nut (74) are tightened into bearing relationship with plate (70) and the sidewall, respectively, of the slotted member (62). By adjusting the position of the sprocket (42b) in this manner, the tension in the roller chain (40) can be adjusted to accommodate different tray assemblies (100) and different loads.

Connection assembly. Each connection assembly couples each of the tray assemblies (100) to the roller chain (40) of the drive mechanism. An embodiment of the connection assembly includes a connector member (80) that attaches a tray assembly (100) to a roller chain (40).

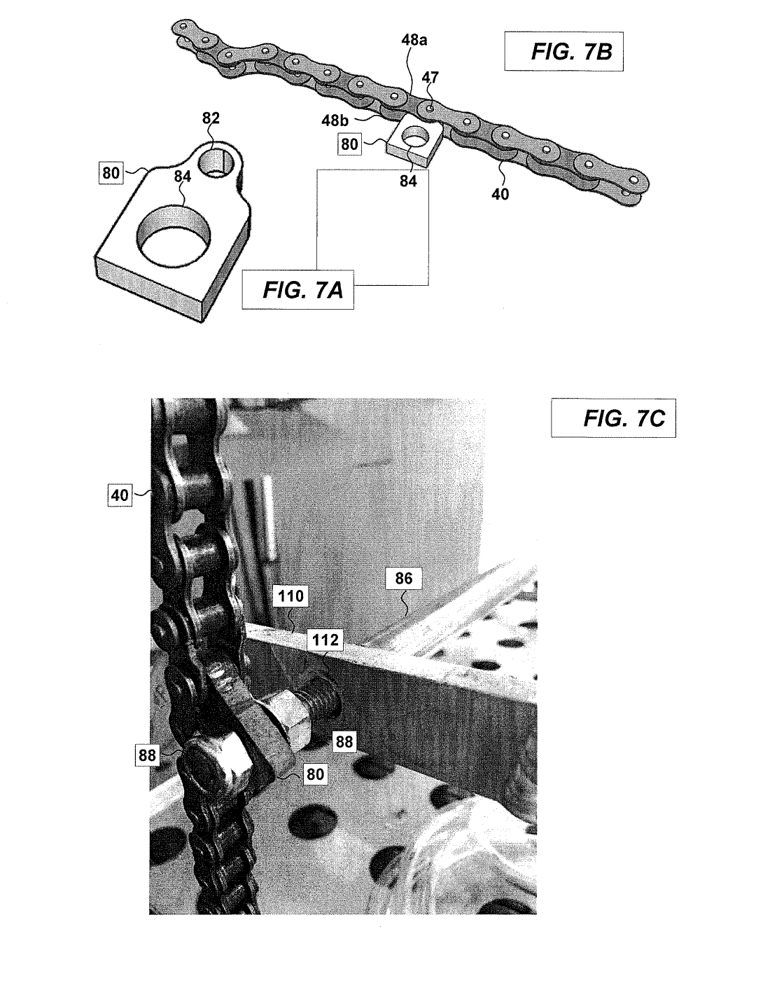

FIG. 7A shows an embodiment of the connector member (80) in isolation. FIG. 7B shows the connector member (80) of FIG. 7A when attached to a roller chain (40). Referring to FIG. 7A, the embodiment of the connector member (80) comprises a flat, plate-like steel member defining an inner aperture (82) and an outer aperture (84). As used herein, the terms “inner” and “outer” are relative terms describing parts of the connector member (80) that are relatively proximal and distal, respectively, to the inside of the loop formed by the roller chain (40) around the sprockets (42) of the drive mechanism. Referring to FIG. 7B, the portion of the connector member (80) that forms the inner aperture (82) is sized and shaped to fit between an opposed pair of plates (48a, 48b) that form the roller chain (40), and the inner aperture (82) is sized to receive one of the pins (47) of the roller chain (40) that connect the associated pair of opposed plates (48a, 48b) of the roller chain (40). Accordingly, the connector member (80) may be installed in the roller chain (40) by disassembling links of the roller chain (40), positioning the connector member (80) between the pair of opposed plates (48a, 48b), aligning the inner aperture (82) of the connector member (80) with the apertures of the opposed plates (48a, 48b), and inserting the associated pin (47) through the aligned apertures. In an embodiment (not shown), the roller chain (40) may be a cottered roller chain (40) known in the art, in which the pins (47) of the roller chain (40) are secured by removable cotter pins to facilitate removal of the pins (47) from the associated plates (48a, 48b) and installation of the connector member (80) in the roller chain (40).

FIG. 7C shows an embodiment of a connector member (80) that connects a roller chain (40) to a tray assembly (100) having a tray hanger (110), in accordance with the embodiment of the apparatus of FIGS. 2A and 2B. A rod (86) is received through the outer aperture (84) of the connector member (80) and an aligned aperture (112) formed in the tray hanger (110) of the tray assembly (100). The rod (86) is in a substantially horizontal orientation, and the tray assembly (100) is free to pivot about the rod (86), so that the orientation of the tray assembly (100) remains constant as the drive mechanism moves the tray assembly (100) through the vertical loop. The connector member (80) is disposed between a pair of nuts (88) on the threaded end portion of the rod (86). The nuts (88) are tightened into bearing relationship with the connector member (80) to limit axial movement of the rod (86) (and hence the tray assembly (100)) relative to the connector member (80).

Tray assemblies. The tray assemblies (100) are used to hold a plant growing medium, which may either be a solid material (e.g., soil, compost, peat, etc.) or a fluid material (e.g., an aqueous solution of nutrients, as used in hydroponic agriculture).

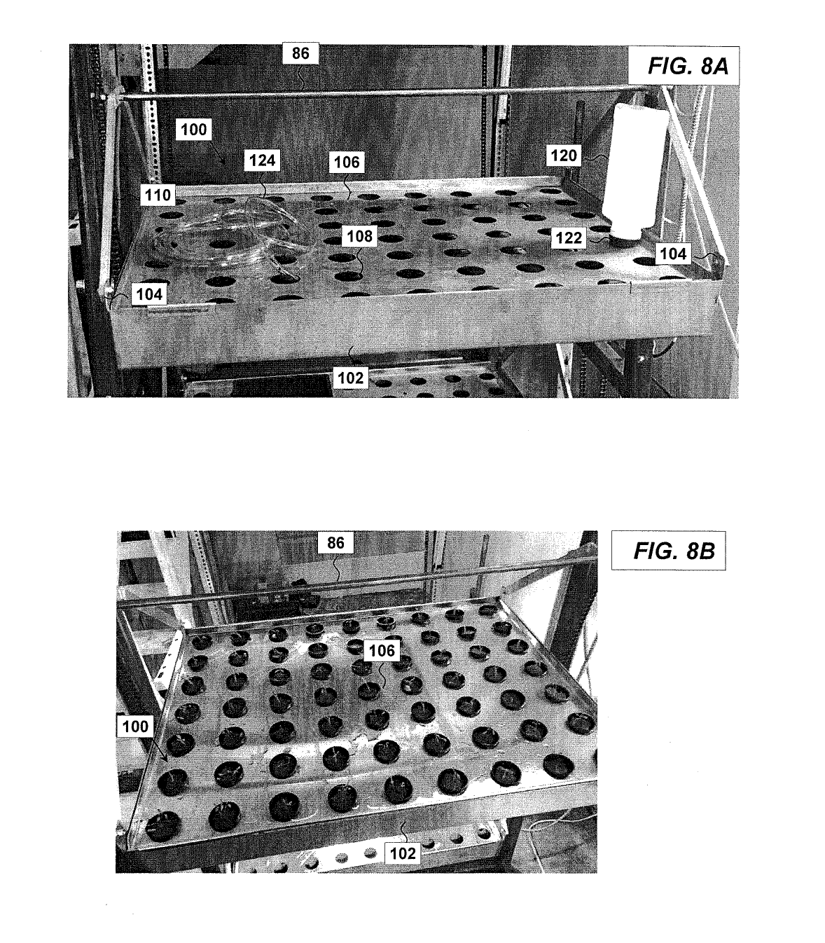

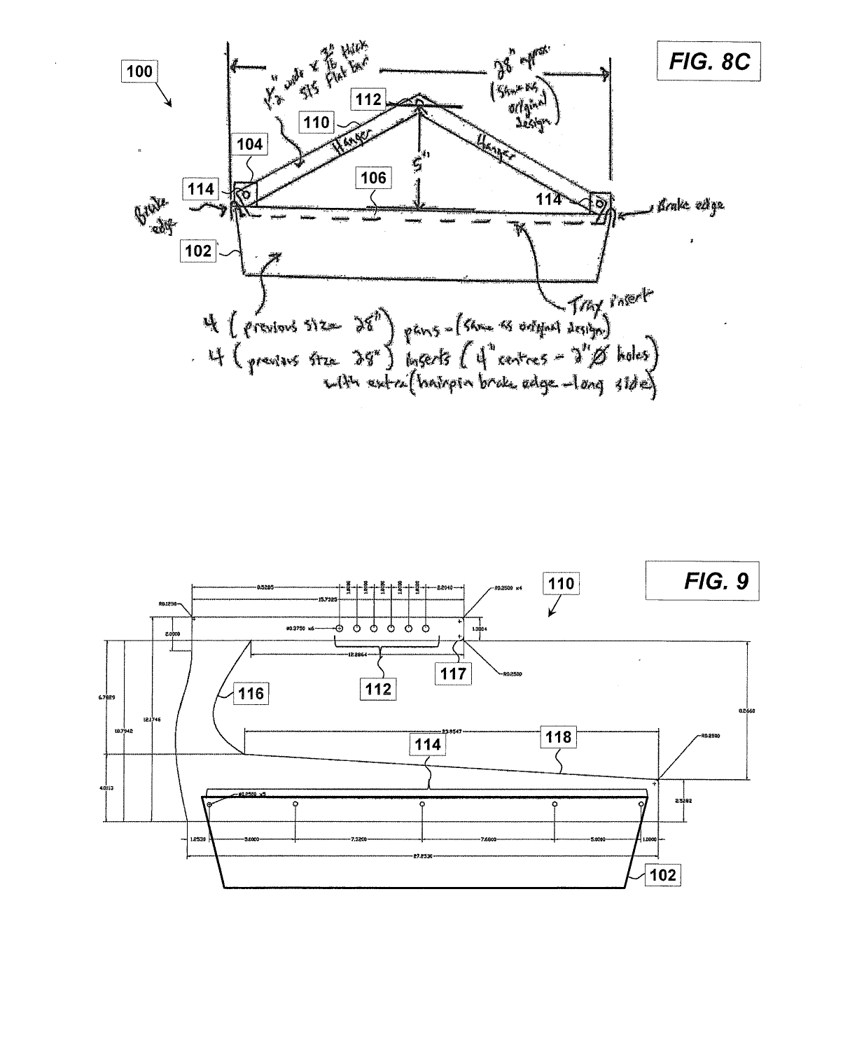

FIG. 8A shows a side view of an embodiment of a tray assembly (100). FIG. 8B shows the tray assembly (100) of FIG. 8A when holding cups that contain foam inserts.

FIG. 8C shows a front view of another embodiment of a tray assembly (100). In the embodiments shown, the tray assembly (100) includes a tray (102), a tray insert (106), and a pair of tray hangers (110). The tray (102) holds the plant growing medium. The tray insert (106) defines tray insert apertures (108) that receive the cups in which plants are grown. The tray insert (106) is optional. In embodiments (not shown) where the tray insert (106) is omitted, the cups or solid plant growing medium is placed directly in the tray (102). The tray hangers (110) suspend the tray (102) from the rod (86) of the connection assembly.

In the embodiment shown in FIGS. 8A and 8B, the tray (102) is made of a single stainless steel sheet that is folded into a substantially rectangular prismatic form measuring about 33 inches wide (84 centimeters) by 46 inches (117 centimeters) long by 4 inches (10 centimeters) deep. The bottom surface and side surface of the tray (102) intersect to form a dihedral angle of greater than 90 degrees. The front and rear surfaces of the tray (102) define a pair of upward extending tabs (104) having apertures to receive bolts that secure the tray hangers (110) to the tray (102).

In the embodiment shown in FIGS. 8A and 8B, the tray insert (106) is made of a single stainless steel sheet. The sheet has a major horizontal surface that defines sixty-three tray insert apertures (108) arranged in array of nine evenly spaced-apart rows and seven evenly spaced-apart columns. The tray insert apertures (108) are circular in shape, and measure about 2 inches (5 centimeters) in diameter so as to receive the cups as shown in FIG. 8B. (Other embodiments may have a different number, arrangement and shape of the tray insert apertures (108).) (In exemplary uses, the portion of the cup extending below the tray insert (106) may be permeable to fluid or define apertures to allow fluid communication of a fluid plant growing medium from the interior of the tray (102) to the interior of the cups.) The front, rear, and side edges of the sheet are folded to define flanges that extend upwardly form the major horizontal surface by about 0.75 inches (1.9 cm), and the side edges of the sheet are bent to define inverted U-shaped hooks that latch onto the sides of the tray (102), to secure the tray insert (106) to the tray (102). Accordingly, when the tray insert (106) is inserted in the tray (102), the major horizontal surface of the tray insert (106) is disposed above the bottom surface of the tray (102).

Tray Hanger. In the embodiment shown in FIGS. 8A to 8C, the tray hangers (110) are made from flat steel bars that are welded together in an inverted V-shape. An aperture (112) is defined by the upper end of the tray hanger (110) to receive the rod (86) of the connection assembly. Apertures (114) are also defined by the bottom ends of the tray hanger (110) to receive the bolts that connect the hangers (110) to the tray (102).

FIG. 9 shows a front view of an alternative embodiment of a tray hanger (110) (all dimensions shown in inches) in relation to a tray (102). In a vertical plane, the tray hanger (110) is substantially C-shaped, having a vertically extending portion (116) connecting to a horizontally cantilevered upper portion (117), and a horizontally cantilevered lower portion (118). The upper portion (117) defines a plurality of horizontally spaced apart apertures (112), which can be used to pivotally receive a rod (86) of the connection assembly. The lower portion (118) defines a plurality of horizontally spaced apart apertures (114) that can be used to receive bolts that connect the hanger (110) to the tray (102). By appropriate selection of one of the apertures (112) and one or more of the apertures (114), the center of gravity of the tray (102) can be horizontally aligned with the rod (86), so that the tray (102) remains horizontally level despite variations in weight distribution of different trays (102) and/or their contents.

As may be seen below, water added to the tray may unbalance the tray and cause the tray to tilt or swing. Unwanted swinging of the tray may be limited by installing a ratchet bearing (not shown) associated with the rod (86), to restrict rotation in one direction and thus limit swinging. As well, the bottom of the tray may be lined with foam or sponge, in order to slow down water flow and/or limit water accumulation in certain areas of the tray.

Watering system. The watering system allows for convenient supply of water or other fluid plant growing medium to the tray (102).

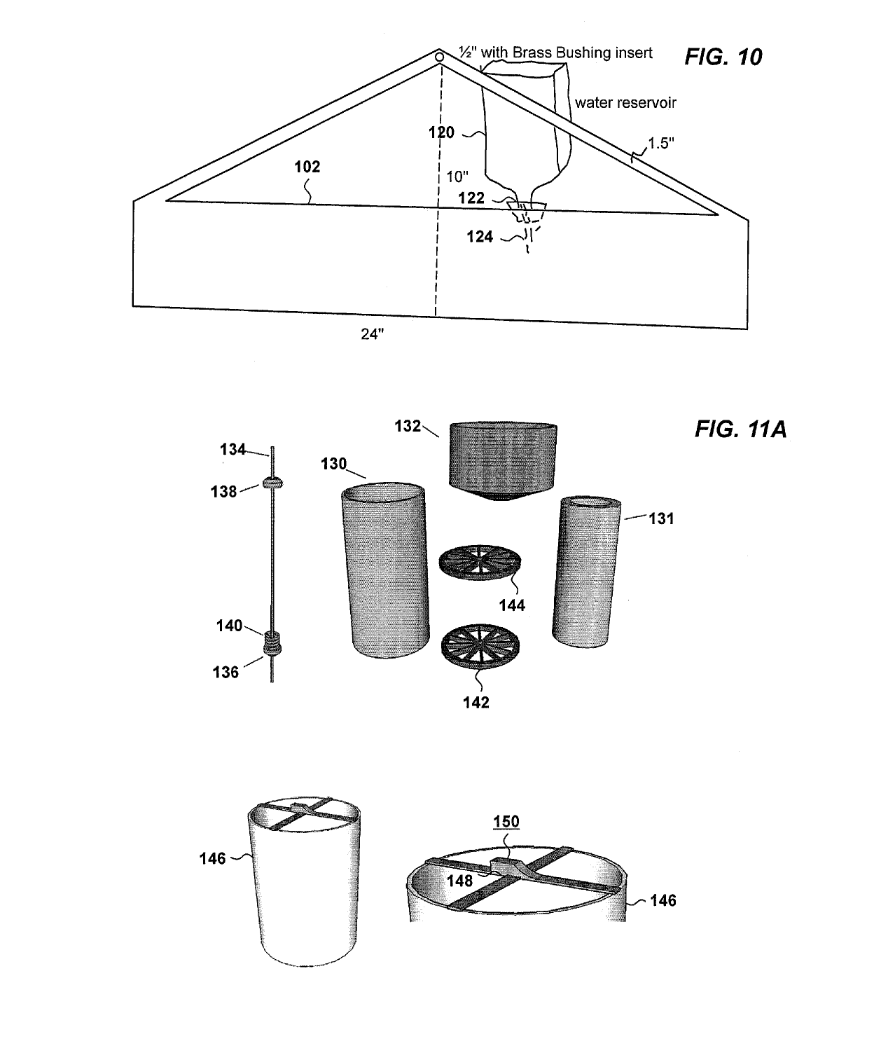

FIG. 10 shows an embodiment of a watering system in relation to the tray (102). In the embodiment, the watering system includes a reservoir (120), a stopper (122), and a length of tubing (124). The reservoir (120) is a plastic container having a capacity of about one liter. The wide top end of the reservoir (120) is open to allow water to be poured into the reservoir (120). The narrow bottom end of the reservoir (120) is inserted and sealed into the stopper (122). The stopper (122) is made of rubber and received and sealed within one of the tray insert apertures (108) defined by the tray insert (106). The plastic tubing (124) extends from an aperture in the stopper (122) into tray (102), and permits fluid communication between the reservoir (120) and the tray (102).

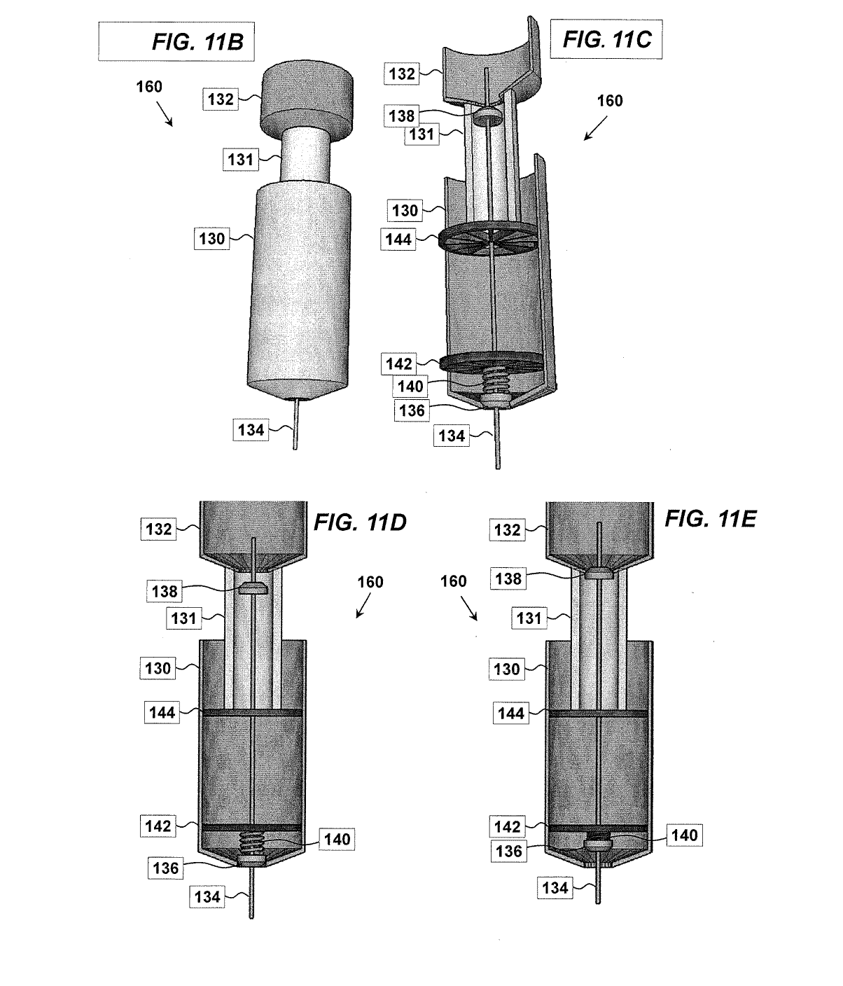

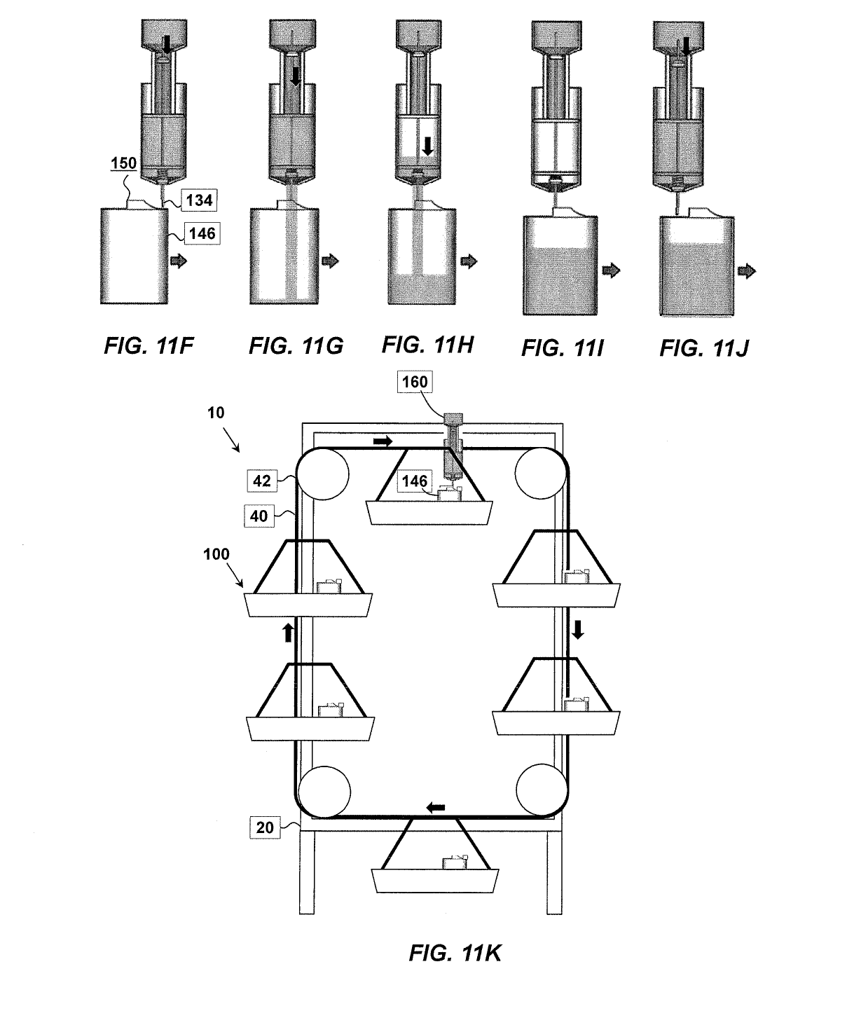

FIG. 11A shows a disassembled perspective view of an embodiment of an alternative watering system. The watering system includes a first reservoir (130) in the form of a cylindrical member, a second reservoir (132) in the form of a tank spout, and a pipe (131) for fluid communication from the second reservoir (132) to the first reservoir (130). The watering system also includes a valve assembly that includes a movable member (134) in the form of a shaft, first and second seal members (136, 138), each of which is in the form an annular rubber stopper disposed around the shaft, and a spring (140) in the form of a coil spring. The watering system also includes first and second supports (142, 144), each in the form of a disc with radiating spokes defining spaces permitting passage of water, and defining a central aperture for passage of the moveable member (134). The watering system also includes a tubular insert (146), and an actuator (148) attached to the upper end of the tubular insert (146). The actuator (148) has an actuator surface (150) that includes an upwardly curving ramped portion followed by an elevated flat portion.

FIG. 11B shows an assembled perspective view of a sub-assembly (160) of the watering system of FIG. 11A. FIG. 11C shows a partial cut-away view of the sub-assembly of FIG. 11B. The first and second supports (142, 144) are retained in the first reservoir (130) by friction fit between their peripheral edges and the inner surface of the first reservoir (130). The moveable member (134) may slide within central apertures defined by each of the first and second supports (142, 144). The first seal member (136) is disposed within the first reservoir (130) and disposed proximal to an outlet at the lower end of the first reservoir (130). The spring (140) is disposed around the moveable member (134), and in between and in bearing relationship with the first support (142) and the first seal member (136). The lower end of the pipe is disposed in the first reservoir (130), and supported therein by resting on the second support (144). The upper end of the pipe (131) is attached to an outlet at the lower end of the second reservoir (132), so as to permit fluid communication from the second reservoir (132) to the first reservoir (130). The second seal member (138) is disposed within the pipe (131) and proximal to the outlet of the second reservoir (132).

FIGS. 11D and 11E show mid-line cross-sectional views of the sub-assembly (160) of FIG. 11B when the moveable member (134) is in the first position and the second position, respectively. In the first position (FIG. 11D), the spring (140) biases upwardly against the first support (142) and downwardly against the first seal member (136) so that the first seal member (136) seals the first reservoir (130) to prevent fluid communication through the outlet of the first reservoir (130). At the same time, the second seal member (138) is disengaged from the second reservoir (132) to permit fluid communication from the second reservoir (130) to the first reservoir (130) via the pipe (131) and the openings of the supports (142, 144). In the second position (FIG. 11E), the first seal member (136) is disengaged from the first reservoir (130) to permit fluid communication through the outlet of the first reservoir (130), while the second seal member (138) engages the second reservoir (132) to prevent fluid communication through the outlet of the second reservoir (132) to the first reservoir (130).

FIGS. 11F to 11J show a sequence of views depicting the operation of the watering system of FIG. 11B, and the resulting flow of water. The downward pointing arrow shows the water level in the first reservoir (130) or pipe (131). The horizontally pointing arrow shows the direction of movement of the tubular insert (146) and actuator (148) relative to the moveable member (134).

In an exemplary use, as shown in FIG. 11K, the tubular insert (146) may be inserted into one of the tray insert apertures (108) such that the tubular insert (146) and attached valve actuator (148) move in unison with one of the trays (102) relative to the frame (20). Meanwhile, the subassembly (160) of FIG. 11B may be attached to the frame (20) so as to remain stationary relative to the frame (20). The subassembly (160) may be attached to any part of the frame (20). In particular, the subassembly (160) may be attached to the frame (20) so that the subassembly (160) waters the tray assemblies (100) at or near the top of the vertical loop (i.e., at the start of the downward leg of the vertical loop). Accordingly, all other factors being equal, the trays assemblies (100) and their contents on the downward leg of the vertical loop will weigh more than the trays assemblies (100) and their contents on the upward leg of the vertical loop as the tray assemblies (100) lose water by evaporation or plant transpiration when circulating through the vertical loop. This weight differential may be sufficient to drive movement of the trays or augment another drive mechanism (e.g., an electric motor).

The second reservoir (132) may be periodically replenished with water as needed. As the tray (102) moves around the loop, the lower end of the moveable member (134) periodically engages and slides along the valve actuator surface (150). Initially, the movable member (134) is in the first position (FIG. 11F), which prevents water from flowing out of the first reservoir (130) into the tubular insert (146), but allows water from flowing from the second reservoir (132) to the first reservoir (130). As the actuator (148) continues to move relative to the moveable member (134), the upwardly curved ramp portion of the actuator surface (150) forces the moveable member (134) upwards against the biasing effect of the spring (140) into the second position (FIG. 11G), thus allowing water to flow from the first reservoir (130) into the tray (102) via tubular insert (146), and preventing water from flowing from the second reservoir (132) to the first reservoir (130). Subsequently, the elevated flat portion of the actuator surface (150) maintains the movable member in the second position sufficiently to allow for continued discharge of water from the first reservoir (130) to the tray (102) via tubular insert (146) (FIG. 11H), until the first reservoir (130) has been emptied of water (FIG. 11I). Once the actuator (148) has moved past the valve assembly (FIG. 11J), the biasing effect of the spring (140) returns the moveable member (134) to the first position, thus preventing water from flowing from the first reservoir (130) into the tubular insert (146), and allowing water to flow from the second reservoir (132) to the first reservoir (130).

Lighting. Referring back to FIGS. 2A and 2B, the apparatus (10) may further include lights for the plants. In the embodiment, the lights are suspended from members attached to the frame (20). The timed operation of the lights may be controlled by an on-site automated system, or remotely controlled with a network connected computing device, such as a smartphone using a wireless control system such as a WiOn™ home control system (Woods Products, Inc. of Carrollton, Ga.). In another embodiment, the lights may be integrated into each tray, in which case timed operation may also be controlled by proximity switches activated as the tray passes certain points in the vertical loop.

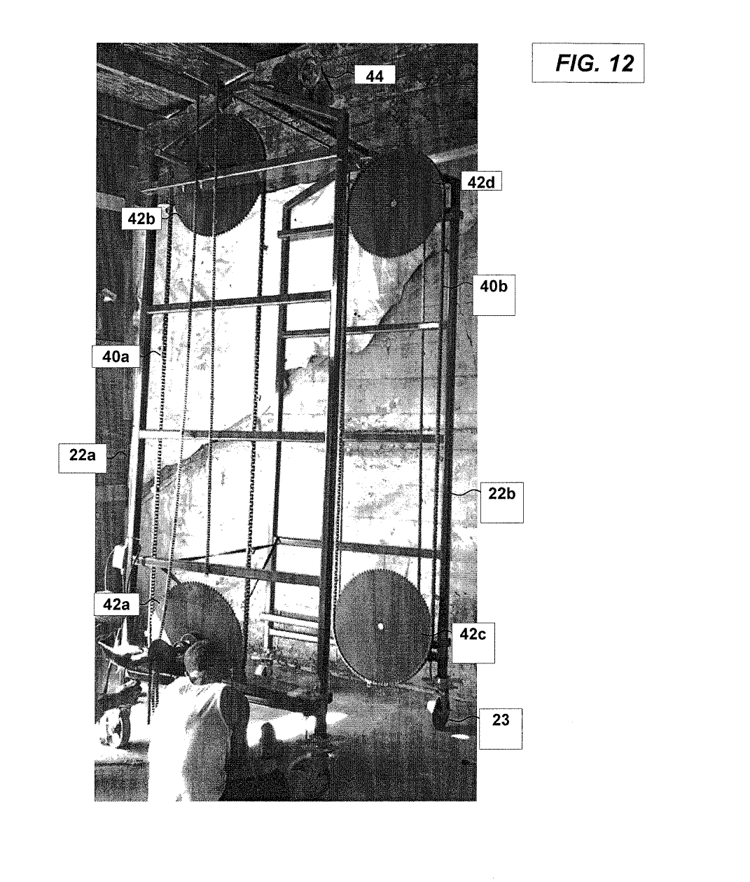

Alternative Embodiment. FIG. 12 shows another embodiment of an apparatus (10) of the present invention, before the tray assemblies (100) are attached to roller chains (40a, 40b). In this embodiment, the frame portions (22a, 22b) are mounted on casters (23) which facilitates adjusting the position of the frame portions (22a, 22b) relative to each other. The drive mechanism has two roller chains (40a, 40b). The first roller chain (40a) is looped around a first vertically spaced apart pair of sprockets (42a, 42b) rotatably mounted to first frame portion (22a). The second roller chain (40b) is looped around a second vertically spaced apart pair of sprockets (42c, 42d) rotatably mounted to second frame portion (22b). The motor (44) is attached to a cross member attached to and spanning between the upper ends of the frame portions (22a, 22b).

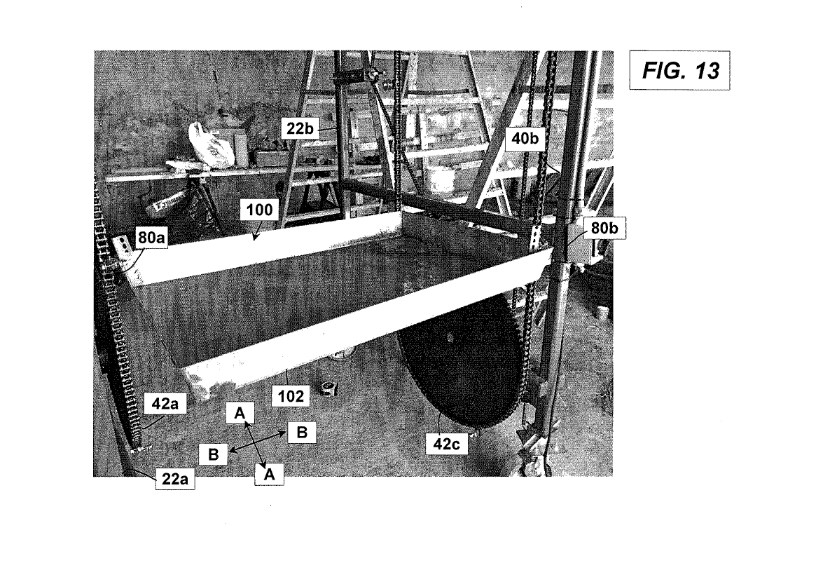

FIG. 13 shows the connection of one of the tray assemblies (100) to the roller chains (40a, 40b) in the embodiment of the apparatus (10) of FIG. 12. The first pair of sprockets (42a, 42b) mounted to the first frame portion (22a) are horizontally offset from the second pair of sprockets (42c, 42d) in the direction of double-arrow line (A-A) to allow for connection of tray assemblies (100), as described below. The horizontal offset distance is approximately equal to the horizontal width of the tray. A first connector member (80a) is attached, via its inner aperture (82), to the first roller chain (40a) in the same manner as described above with reference to FIGS. 8A and 8B. The first connector member (80a) is also attached, via its outer aperture (84) and an associated nut and bolt fastener, to an aperture formed near one of the corners of the tray (102) of the tray assembly (100). The second connector member (80b) is similarly attached to the second roller chain (40b), and to an opposite corner of the tray (102) of the tray assembly (100). Accordingly, different portions of the tray (102) that are horizontally spaced apart in two mutually perpendicular directions (i.e., the directions shown by arrow line (A-A) and arrow line (B-B)) are supported by chains (40a, 40b). This manner of connection may avoid or limit undesired swinging motion of the tray assembly (100), which can be particularly important when the tray is used to contain a liquid growth medium.

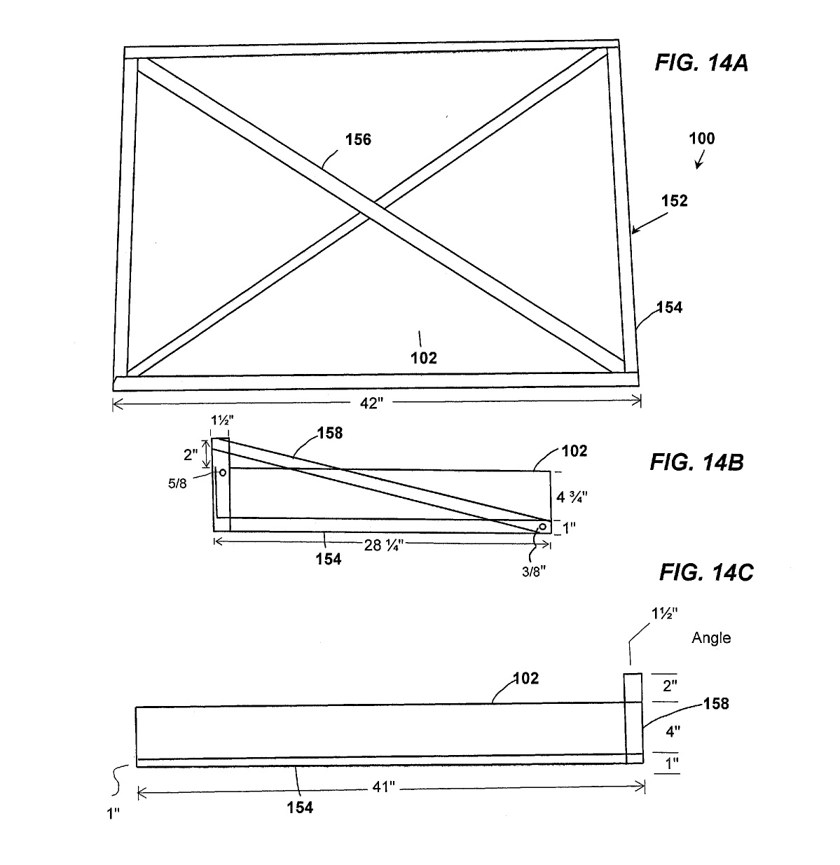

FIGS. 14A, 14B and 14C show a bottom plan view, an end elevation view, and a side elevation view, respectively, of another embodiment of a tray (102), which may be suited for use with the embodiment of the apparatus (10) shown in FIGS. 12 and 13. Referring to

FIG. 14A, the embodiment of the tray assembly (100) includes a tray (102) and a supporting frame (152). The tray (102) has a rectangular shape measuring approximately 42 inches (106 cm) in length, and 28 inches (71 cm) in width, and 4.75 inches (12 cm) in depth. The tray is formed from stainless steel sheet having a thickness of approximately 1/16 of an inch (16 gauge). The support frame (152) supports the tray (102) to limit deformation of the tray (102). The support frame (152) is made of tubular stainless steel members having a hollow square cross section measure approximately 1 inch (2.5 cm)×1 inch (2.5 cm). Some of the members (154) form a rectangular frame that lies beneath the tray (102). Other members (156) form diagonal cross braces of the rectangular frame in the plane of the rectangular frame (see FIG. 14A). Other members (158) in the form of angles are attached to the rectangular frame to brace the support frame (152) in the vertical plane (see FIGS. 14B and 14c).

Additional Interpretation. References in the specification to “one embodiment”, “an embodiment”, etc., indicate that the embodiment described may include a particular aspect, feature, structure, or characteristic, but not every embodiment necessarily includes that aspect, feature, structure, or characteristic. Moreover, such phrases may, but do not necessarily, refer to the same embodiment referred to in other portions of the specification. Further, when a particular aspect, feature, structure, or characteristic is described in connection with an embodiment, it is within the knowledge of one skilled in the art to affect or connect such module, aspect, feature, structure, or characteristic with other embodiments, whether or not explicitly described. In other words, any module, element or feature may be combined with any other element or feature in different embodiments, unless there is an obvious or inherent incompatibility, or it is specifically excluded.

It is further noted that the claims may be drafted to exclude any optional element. As such, this statement is intended to serve as antecedent basis for the use of exclusive terminology, such as “solely,” “only,” and the like, in connection with the recitation of claim elements or use of a “negative” limitation. The tenns “preferably,” “preferred,” “prefer,” “optionally,” “may,” and similar terms are used to indicate that an item, condition or step being referred to is an optional (not required) feature of the invention.

The singular forms “a,” “an,” and “the” include the plural reference unless the context clearly dictates otherwise. The term “and/or” means any one of the items, any combination of the items, or all of the items with which this term is associated. The phrase “one or more” is readily understood by one of skill in the art, particularly when read in context of its usage.

The term “about” can refer to a variation of ±5%, +10%, ±20%, or +25% of the value specified. For example, “about 50” percent can in some embodiments carry a variation from 45 to 55 percent. For integer ranges, the term “about” can include one or two integers greater than and/or less than a recited integer at each end of the range. Unless indicated otherwise herein, the term “about” is intended to include values and ranges proximate to the recited range that are equivalent in terms of the functionality of the composition, or the embodiment.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. A recited range includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third and upper third, etc.

As will also be understood by one skilled in the art, all language such as “up to”, “at least”, “greater than”, “less than”, “more than”, “or more”, and the like, include the number recited and such terms refer to ranges that can be subsequently broken down into sub-ranges as discussed above. In the same manner, all ratios recited herein also include all sub-ratios falling within the broader ratio.

1. A watering system for use with a vertical agriculture apparatus comprising a tray for holding a plant growth medium, and a drive mechanism for moving the tray in a vertical loop, the watering system comprising:
(a) a first reservoir;
(b) a first seal member;
(c) a moveable member to which the first seal member is attached, wherein the moveable member is moveable between a first position wherein the first seal member prevents fluid communication from the first reservoir to the tray, and a second position wherein the first seal member permits fluid communication from the first reservoir to the tray;
(d) a spring for biasing the moveable member to the first position; and
(e) an actuator for direct or indirect attachment to the tray, the actuator comprising a surface contoured to move the moveable member from the first position to the second position when the surface is moved, by the tray, in sliding engagement with the moveable member.

2. The watering system of claim 1, further comprising:
(a) a second reservoir; and
(b) a second seal member attached to the moveable member, wherein when the movable member is in the first position, the second seal member prevents fluid communication from the second reservoir to the first reservoir, and wherein when the moveable member is in the second position, the second seal member permits fluid communication from the second reservoir to the first reservoir.

3. The watering system of claim 1, wherein the vertical agriculture apparatus further comprises a tray insert defining an aperture above a bottom surface of the tray, wherein the watering system further comprises a tubular insert for insertion into the aperture to direct fluid from the first reservoir to the tray, and wherein the actuator is attached to the tubular insert.

4. (canceled)

5. (canceled)

6. A vertical agriculture apparatus comprising:
(a) a vertical frame;
(b) a first drive belt or chain forming a first vertical loop;
(c) a second drive belt or chain forming a second vertical loop, wherein the first vertical loop and the second vertical loop are spaced apart from each other in a first horizontal direction;
(d) a tray for holding a plant growth medium attached, wherein a first portion of the tray is attached to the first loop, and a second portion of the tray is attached to the second loop, wherein the first portion of the tray and the second portion of the tray are spaced apart from each other in the first horizontal direction and a second horizontal direction perpendicular to the first horizontal direction; and
(e) a drive mechanism for moving the first belt and the second belt, and thereby drive the tray in a continuous vertical loop.

7. The apparatus of claim 6 further comprising a tray hanger for pivotally suspending the tray from a rod connected to the first and second drive chain or belt, the tray hanger comprising:
(a) a lower portion for attachment to the tray; and
(b) an upper portion defining a plurality of horizontally spaced apart apertures sized to pivotally receive the rod.

8. The apparatus of claim 7 further comprising a ratchet bearing associated with the rod for limiting rotation of the rod or the tray hanger in one direction.

9. The apparatus of claim 6 further comprising a watering system comprising:
(a) a first reservoir;
(b) a first seal member;
(c) a moveable member to which the first seal member is attached, wherein the moveable member is moveable between a first position wherein the first seal member prevents fluid communication from the first reservoir to the tray, and a second position wherein the first seal member permits fluid communication from the first reservoir to the tray;
(d) a spring for biasing the moveable member to the first position; and
(e) an actuator for direct or indirect attachment to the tray, the actuator comprising a surface contoured to move the moveable member from the first position to the second position when the surface is moved, by the tray, in sliding engagement with the moveable member.

10. The apparatus of claim 9, further comprising:
(a) a second reservoir; and
(b) a second seal member attached to the moveable member, wherein when the movable member is in the first position, the second seal member prevents fluid communication from the second reservoir to the first reservoir, and wherein when the moveable member is in the second position, the second seal member permits fluid communication from the second reservoir to the first reservoir.

11. The apparatus of claim 9, wherein the vertical agriculture apparatus further comprises a tray insert defining an aperture above a bottom surface of the tray, wherein the watering system further comprises a tubular insert for insertion into the aperture to direct fluid from the first reservoir to the tray, and wherein the actuator is attached to the tubular insert.

12. The apparatus of claim 6 wherein either one or both of the first chain and the second chain comprise a roller chain, wherein the roller chain comprising a plurality of pins connecting an associated pair of opposed plates, wherein the tray defines a tray aperture, wherein the apparatus comprises a connection assembly, the connection assembly comprising a connector member defining:
(a) an inner aperture for receiving one of the pins of the roller chain, and disposed between the associated pair of opposed plates; and
(b) an outer aperture for alignment with the tray aperture and receiving therethrough a bolt or rod when aligned with the tray aperture.

13. The apparatus of claim 6 further comprising a plurality of trays spaced apart along the first drive belt or chain, and comprising a watering system configured to add water to the trays on a downward leg of the vertical loop.

14. A method of driving a vertical agriculture apparatus comprising a vertical frame, a pair of drive belts or chains, each forming spaced-apart parallel vertical loops, a tray for holding a plant growth medium attached between the drive belts or chains, the method comprising the step of adding water to the tray on a downward leg of the vertical loop, thereby gravity assisting the descent of the tray, to independently drive the travel of the vertical loop, or augment a drive mechanism.

15. The apparatus of claim 12 wherein the connection assembly further comprises a pair of nuts attached to a threaded portion of the bolt or rod and engaged with the tray to limit translational movement of the tray in relation to the bolt or rod.
